(19) United States
(12) Patent Application Publication
(10) Pub. No.: US 2005/0083314 A1
(43) Pub. Date: Apr. 21, 2005

(54) Computerized portable handheld means

(76) Inventors: Tomer Shalit, Umea (SE); Anders Haggestad, Uppsala (SE)

Correspondence Address: NIXON & VANDERHYE, PC, 1100 N GLEBE ROAD, 8TH FLOOR, ARLINGTON, VA, 22201-4714, US

(21) Appl. No.: 10/484,318

(22) PCT Filed: Jul. 3, 2002
(86) PCT No.: PCT/SE02/01329

(30) Foreign Application Priority Data
Jul. 22, 2001 (SE) 0102583.2

(51) Int. Cl. G09G 5/00

(52) U.S. Cl. 345/179

(57) ABSTRACT

The invention relates to a computerized portable handheld means (10) with a screen (16) for the display of objects (19) to be manipulated, and a method therefore. It has two type of means for manipulation; one for a hand holding it, and one when it is placed on another surface. A tactile providing means provides a tactile feedback to a hand holding a pointing means (20) when manipulating an object (19). It thus provides an enhanced browsing through available objects (19) by the use of at least the two human senses seeing and feeling.

### TECHNICAL FIELD

The present invention pertains to a computerized portable handheld means with a screen for the display of objects to be manipulated, whereby manipulated objects provide a link to a sub-object or function to be performed by the manipulation. It also provides a method therefore. In a specific embodiment it provides a stereoscopic screen for three-dimensional display of objects to be manipulated.

### BACKGROUND ART

Portable handheld computerized devices, such as palm-top-computers, PDA (Personal Digital Assistance) and cellular phones, have a drawback in displaying objects due to their relatively small screen for display. This means that a user of such a device has to push or activate a lot of buttons in order to browse through, for example, all available menus that allow a handheld device to be user-friendly. A browsing through such menus is thus very time consuming, and the possibility to rapidly display a multiple choice of menus is highly restricted.

Another drawback with current portable handheld devices relates to tactile feed-back when manipulating widgets on a screen, for example, it is not practically accomplished to tilt such a device when it is placed on a surface other than a palm of a human being in order to manipulate a widget on a screen. Hence there is a need for at least two procedures when manipulating a widget; one for the device when held in a palm, and one for it when it lies down on another surface.

Further, it should be appreciated that a selection of, for example, a menu could be verified so that a user of a handheld computerized device is provided an indication of a selection.

Patent document US-A-5 657 054 by Files et al discloses the determination of a pen location on a two-dimensional display apparatus, for example a computer screen, through piezoelectric point elements.

The patent document US-A-5 500 492 by Kobayashi et al discloses a coordinate input apparatus for detecting an input vibration from a vibration pen. Coordinates are determined only in two dimensions.

In the U.S. patent document US-A-5 818 424 by Korth a rod-shaped device for spatial data acquisition is described. The position of the device in three-dimensions is determined through an optical system.

The patent document US-A-4 246 439 by Romein describes an acoustic writing combination including a stylus with an associated writing tablet. The stylus is provided with an ultrasonic sound source emitting pulse signals which are picked up by at least two microphones arranged on the writing table to determine the position of the stylus in two dimensions.

Embodiments of the present invention with its advantages are described through the attached independent claims. Further embodiments and advantages are described through the attached dependent sub-claims.

### SUMMARY OF THE DISCLOSED INVENTION

It is a subject of the present invention to provide a computerized portable handheld means with a stereoscopic screen for 2-D and/or 3-D browsing and manipulation with two manipulating means; one used when holding the means in a palm such as during walking, and one for placing it on another surface, such as a table.

In order to achieve aims and subjects of the present invention it sets forth a computerized portable handheld means with a screen displaying images of objects to be manipulated, whereby a manipulation of objects connects a link to a sub-object or function to be performed, comprising:
a first manipulating means for said objects, controlling the manipulation of said objects by movement of a hand holding said manipulating means;
a second manipulating means for said objects, controlling the manipulation of said objects by a pointing device when it is placed on another surface than a hand; and
a means for providing tactile feedback to said hand for every successful possible manipulation of said object, thereby providing a push-button free manipulation of objects and a feeling for the manipulation, thus enhancing the speed of manipulation by involving at least the two senses of seeing and feeling, and providing at least two functions of manipulating objects on a screen in accordance with said first and second means.

In one embodiment of the present invention it is provided with a gyro, whereby the degree of tilting it constitutes an input signal to said first and second manipulating means which controls the degree of manipulation of objects.

Another embodiment comprises that a zero base for the manipulation is provided by an agreement action provided by a bearer of it, no matter in what direction or angle it is held when said action is provided.

A tilting of the portable handheld means in a vertical plane to its length axis determines the degree of manipulation of an object in one embodiment, and where a rotation of it around its axis determines an approval of the manipulation.

In another embodiment of the invention a position detecting means for a 3-D determination of said pointer device stylus position in space is an ultrasonic receiver/transmitter means.

In a further embodiment the position detecting means is a miniaturized camera means.

Further in one embodiment a 3-D image provides a skin layer with menus. The manipulating means is locked to a skin layer when having provided a tactile feedback, whereby the manipulating means is used for browsing on the skin layer surface, thus preventing slipping to an adjacent skin layer.

A still further embodiment of the present invention comprises that it is a cellular phone.

Yet another embodiment provides that it is a palm-top-computer or the like.

A further embodiment sets forth that the screen is of an auto-stereoscopic type.

The present invention also sets forth a method for a computerized portable handheld means with a screen displaying images of objects to be manipulated, whereby a manipulation of objects connects a link to a sub-object or function to be performed, comprising the steps of:
providing a first manipulating means for said objects, controlling the manipulation of said objects by movement of a hand holding said manipulating means;
providing a second manipulating means for said objects, controlling the manipulation of said objects by a pointing device when it is placed on another surface than a hand; and
providing a means for tactile feedback to said hand for every successful possible manipulation of said object, thereby providing a push-button free manipulation of objects and a feeling for the manipulation, thus enhancing the speed of manipulation by involving at least the two senses of seeing and feeling, and providing at least two functions of manipulating objects on a screen in accordance with said first and second means.

The method of the present invention is able to perform embodiments relating to the embodiments of the handheld portable means, especially in accordance with the attached set of method sub-claims.

### BRIEF DESCRIPTION OF THE DRAWINGS

Henceforth reference is had to the attached drawings and its accompanying text for a better understanding of the present invention with its embodiments and examples, wherein;

FIG. 1 schematically illustrates the use of a pointer device for manipulation of an object displayed on the screen of a portable handheld means in accordance with the present invention; and

FIG. 2 schematically illustrates a handheld means for a tilting, in the directions of depicted arrows, of the means for manipulation of a widget in accordance with the present invention.

### DETAILED DESCRIPTION OF PREFERRED EMBODIMENTS

There is a need to solve problems relating to the display of data on relatively small electronic devices such as palm held equipment, for example, cellular phones, Personal Digital Assistant (PDA), or any hand held device with a screen. Hence the present invention provides a portable hand held means that introduces a two-dimensional (2-D) and/or a three-dimensional (3-D) space on or above, respectively, a screen for manipulating, browsing or scrolling through computer software which presents graphics on the screen for the selection/manipulation of objects, functions or other features. Graphics as those displayed on a screen are commonly addressed as widgets in computer art.

An advantage feature introduced by the present invention relates to a portable handheld means as mentioned with the functions of using a pointing device to manipulate a widget, menu etc when it is placed on and upheld of a surface such as a table or any other resting area not being the palm of a human being, and when held by the palm of a human being, the manipulating is accomplished by tilting of the hand held means.

It is also an aim of the present invention to provide tactile feed-back to a user of such a handheld device when manipulating or selecting objects displayed on the screen with a pointing device such as the stylus of a pen like pointer, or any other suitable pointing device, for communication between it and the portable handheld device.

A 3-D space in accordance with the present invention can in one embodiment be created with the use of auto-stereoscopic techniques. A stereo screen provides different pictures of the same object to a persons left and right eye, whereby a viewer of the picture experiences it as 3-D image. Stereo screens are commonly provided with the aid of, e.g. red-green-glasses or a type of polarized glasses or glasses with a shutter.

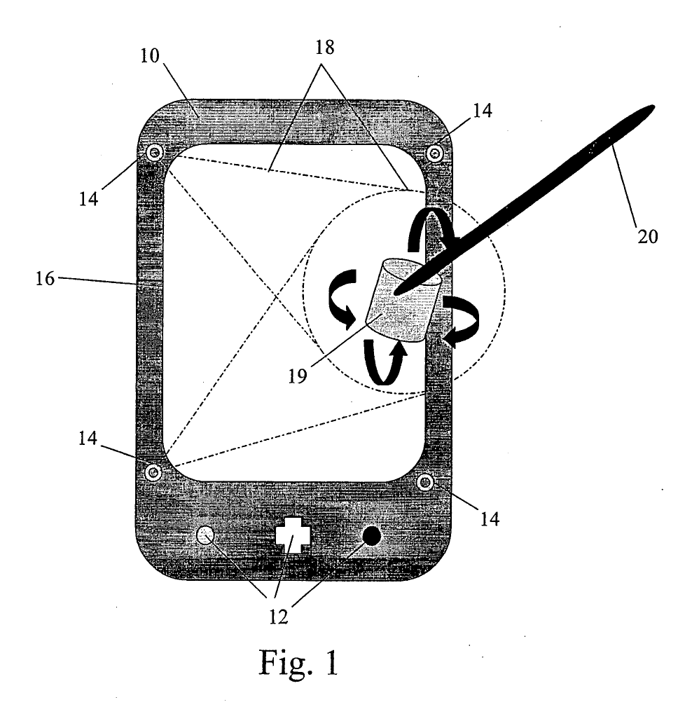

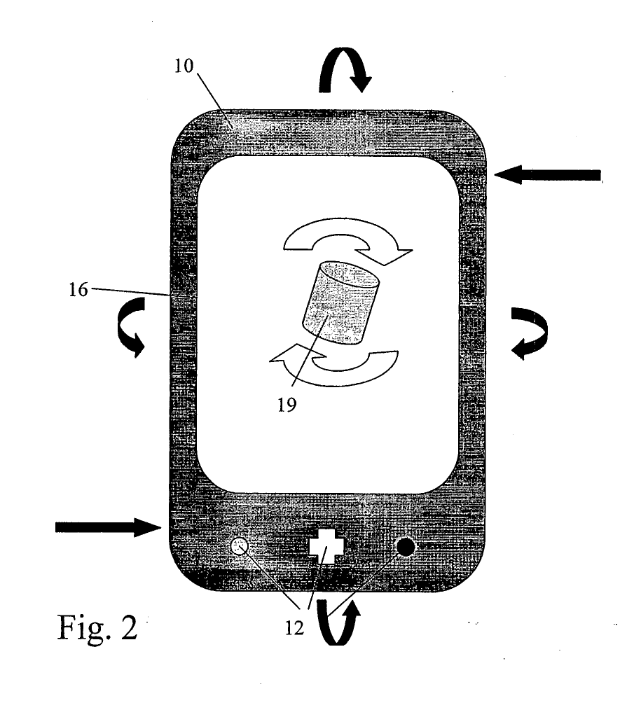

FIG. 1 schematically illustrates a PDA 10 or like device with function or entering keys 12 and a screen 16. These keys 12 could be of any type available on the market such as touch pad, screen touch pad technique keys or the like. In FIG. 1 the function of using a pointing device 20 when the portable handheld means 10 is placed on a plane surface is illustrated in accordance with the present invention. This provides a major advantage when using a hand-held device 10. A hand-held device 10 can be used either when placed on a surface not being the palm of a human being, for example, a table, or vice versa. In FIG. 2 below the function of manipulating a widget 19 held in the palm of a human being is described, which is a second advantage of the present invention.

Hence, there are two situations or functions described about how to manipulate a widget or browsing in a menu is accomplished by the present invention. One according to FIG. 1 where the means 10 is placed on, for example, a table, and one where it is placed in the palm of a human being possibly during walking, standing, sitting etc, see FIG. 2. It is not excluded that other manipulating means such as a touch pad or the like can be used as well.

Depicted as 14 in the FIG. 1 are microphones, receivers for transmitted ultra sound, which pick up ultra sound transmitted from a ultra sound transmitter (not shown) as described in prior art techniques and further described below. The microphones pick up sound waves reflected from a stylus of a pointer device 20 to pin point the position of the stylus in the 3-D space. Other known devices for positioning in a 3-D space can be accomplished through optical means emitting and collecting reflected light or even be of a camera type using CCDs.

The use of a pointer device 20 for manipulation of a widget 19, here a cylinder, displayed on the screen 16 of a portable handheld means 10 in accordance with one embodiment of the present invention is depicted by the arrows in FIG. 1. The arrows depicted in FIG. 1 illustrate the movement of a computer-pointing device 19 in a 3-D space created above the screen. This movement is thus transferred to the widget 19, which is manipulated in accordance with the movement of the pointing device 20 according to in the art well known software principles or techniques.

In one embodiment of the invention the stylus of the pointing device is represented as a virtual projection on the screen 16, for example, as a cursor.

One way to accomplish a 3-D environment on a screen 16 is through auto-stereoscopic screens. The auto-stereoscopic space 18 in FIG. 1 is depicted as dotted lines. Auto-stereoscopic screens deliver different pictures of the same object/widget to the left and right eye of a person, without the use of any glasses. The Cambridge Auto-stereoscopic display allows a viewer to see a true three-dimensional picture. Each of the viewer's eyes sees a different image of a displayed scene, just as in real life, and the viewer can move its head to “look around” or grasp the outlining and details of objects in a scene. This results in an auto-stereoscopic vision, whereby it is perfectly natural because there is no need for any special glasses or other headgear.

A multi-view auto-stereoscopic display requires multiple distinct pictures of an object to be viewed, taken from distinct viewing positions. These multiple pictures are very quickly flashed up on, for example, a cathode ray tube (CRT), one after another. At the instant as one of the pictures is being displayed, one of a set of liquid crystal shutters is opened, making the picture visible to part of the area in front of the display. The shutters determine where the observer can view each of the pictures. This process is repeated very rapidly, sixty times a second. Each of the observer's eyes thus views a series of very short, and very bright images of one of the pictures. The eye integrates these short bursts of pictures to give the effect of a continuously displayed picture. Because each eye views a different picture, an observer receives one of the important 3-D depth cues: stereo parallax. Further, because the observer views different pictures when moving its head, it is provided another important 3-D depth cue: movement parallax. These two depth cues combine to provide an effective illusion of real depth in the 3-D imaging.

In another embodiment a relatively new auto-stereoscopic display system based on direct view liquid crystal display (LCD) and holographic optical elements (HOEs) is considered. The display uses a composite HOE to control the visibality of pixels of a conventional LCD. One arrangement described uses horisontal line interlaced spatially multiplexed stereo images displayed on the LCD to provide an easy to viewe autosteroscopic (i.e. glasses-free real 3-D) display. It is compatible with existing glasses-based stereo system using the so-called field sequential method coupled with shutter systems. (e.g LCD shuttered glasses).

The present invention also provides known means for determining the position of a computer-pointing device in a 3-D space. One such means provides ultra-sonic positioning. The pointing device is equipped with a microphone collecting sound bursts transmitted from a plurality of ultra sound transmitters attached at different positions on a portable computer device in accordance with the present invention. An ultra-sonic positioning is accomplished through triangulation of the sound bursts distance in accordance with established techniques, time of flight, from at least three loudspeakers.

Further, the position detecting means could be a miniaturized camera means, as described in prior art.

An advantage with the present invention, not known in the art, is the feature of tactile feedback when manipulating an object on a display, displaying 3-D objects such as widgets, menus etc on a portable handheld computer screen. A tactile feedback can be provided by for example a piezo-electric actuator or like actuators creating vibrations or thrusts, impulses etc. A widget is a frequently used term amongst persons skilled in providing at least computer images, and refers to any kind of object that could be manipulated with computer pointing or selecting devices, such as a button, icons, and other designed shapes.

The present invention provides tactile feedback either by a vibration or an impulse delivered from the handheld means itself in one embodiment and/or from a pointer device 20 such as a pen with a stylus used with, for example, PDAs or a cellular/mobile phone, see FIG. 1.

In one embodiment of the present invention, the tactile feed-back is also made visible to a persons eyes by letting the screen 16 be attached to an elastic or spring movement means, whereby the screen 16 protrudes or vibrates when the tactile feedback is activated. Such spring moved screens are known in the art.

FIG. 2 schematically illustrates the same handheld means 10 as in FIG. 1 with its six dimensions of possible tilting in accordance with the filled out arrows depicted in FIG. 2. The filled out arrows indicate degrees in steps of a possible tilting of the means 10 in accordance with the present invention. Each degree of a step when tilting is followed by a tactile feedback in one embodiment of the present invention. Here the portable handheld means 10 itself acts as a pointing means, i.e., the tilting or displacement of the handheld means 16 determines where, for example a cursor, is placed in a 2-D or 3-D space.

The non filled out white arrows on the screen 16 in FIG. 2 indicate a possible manipulation of the widget 19.

As an example, a change from using a pointing device 20 for the tilting as described could be arranged through the pushbuttons 12. Selections when tilting could be made through another pushbutton 12 or in any other fashion as known in the art.

In one embodiment of the present invention a low or slow tilting of the means 10, the speed of browsing or manipulating is accomplished slow and in an even pace. This assists a user of the PDA 10 to make a selection at the end of a scrolling session.

An application example of the tilting function is pull down menus, the menu to the left is thus marked, and fields of the marked menu are indicated through horizontal tilting of the hand-held means 10, as indicated by the two horizontal arrows in FIG. 2. In order to activate or mark a new menu, the means 10 is tilted in a vertical direction indicated by the two arrows on the means short sides in FIG. 2.

Another application example relates to a phone book where the tilting function can be used for quick browsing through a list of telephone numbers, whereby the list is built up like a virtual wheel, and the rotation of the “wheel” is thus directly linked to the tilting of the hand-held means 10.

When the computerized portable handheld means in accordance with the present invention has a screen 16 producing a stereoscopic 3-D image of objects to be manipulated, as described above. A manipulation of objects connects a link to a sub-object or function to be performed. As an example of a function it could be to rotate any kind of 3-D objects and any known manipulation in computer added design (CAD). A sub-object can be a new object linked to a primary object, for example, pressing a widget 19 such as a button connecting to a new object which could be a menu for browsing and selecting functions. This is also true for a 2-D projection on the screen 16.

Hence, the portable handheld means 10 of the present invention is provided with a manipulating means for 2-D or 3-D objects, whereby it controls manipulation of those objects by movement of a hand holding the manipulation means. The manipulating means is in one embodiment the housing of the handheld means such as a PDA, mobile phone etc. In this embodiment the handheld means is equipped with a means for determining gyro information to, for example, a software that is designed to control a tactile feedback providing means, for instance such as mentioned before. In one embodiment a tactile feedback could be provided every time a predetermined degree of gyro information is given, named steps above, when manipulating an object. A tactile feedback could also be given when the movement of the handheld device makes the display of an object change from one object to another, for example, when changing between menus.

The portable handheld means 10 has also a manipulating means in accordance with the present invention that is a computer pointing means such as a pen like pointing/manipulating device used when the handheld means 10 is placed on a surface other than the palm of a human being.

The handheld means of the present invention is thus able to provide a push-button free manipulation of objects and a feeling for the manipulation. The more human senses involved in a decision, the faster a decision could be accomplished. In most cases this would be true at least when the decision is to manipulate widgets 19. Hence, the present invention enhances the speed of manipulation by involving at least the two senses of seeing and feeling.

A tactile feedback could also be enhanced by the production of a sound, such as a click, when providing the feedback, thus introducing a third human sense of hearing.

When the portable handheld device is provided with a gyro (piezo-electric, mercury switch or the like), in one embodiment, the degree of tilting the device constitutes an input signal to the manipulating means which controls the degree of manipulation of objects. In order to establish a zero base for the gyro, the manipulation is provided by an agreement action provided by a bearer of it, no matter in what direction or angle it is held when the action is provided. Such an action could be accomplished by pressing, for example, a widget making up a push/touch-button. A tilting of it in a vertical plane to its length axis determines the degree of manipulation of an object, and a rotation of it around its axis determines an approval of the manipulation in one embodiment. Other like tilting actions could be provided in accordance with the scope of the present invention.

An advantage embodiment of the present invention provides that the 3-D image is made up of menus in a skin layer fashion. Skin layers, in computer graphic display, provide a stack/pile of for instance menus, whereby a 3-D space on a screen can provide an almost infinite pile of menus, only limited by the resolution of a 3-D presentation. The manipulating means is locked to a skin layer, in one embodiment, when having provided a tactile feedback or/and other agreement action, whereby the manipulating means is used for browsing on the skin layer surface, thus preventing slipping to an adjacent skin layer.

The present invention has been described through embodiments and examples, which should not be regarded as limiting to the scope of the invention. The attached set of claims describes the scope of the invention to a person skilled in the art.

1. A computerized portable handheld means (10) with a screen (16) displaying images of objects (19) to be manipulated, whereby a manipulation of objects connects a link to a sub-object or function to be performed, comprising: a first manipulating means for said objects, controlling the manipulation of said objects by movement of a hand holding said manipulating means; a second manipulating means for said objects, controlling the manipulation of said objects by a pointing device (20) when it is placed on another surface than a hand; and a means for providing tactile feedback to said hand for every successful possible manipulation of said objects, thereby providing a push-button free manipulation of objects and a feeling for the manipulation, thus enhancing the speed of manipulation by involving at least the two senses of seeing and feeling, and providing at least two functions of manipulating objects (19) on a screen in accordance with said first and second means.

2. A handheld means according to claim 1, wherein it is provided with a gyro, whereby the degree of tilting it, constitutes an input signal to said first and second manipulating means which controls the degree of manipulation of objects (19).

3. A handheld means according to claim 1, wherein a zero base for a manipulation is provided by an agreement action provided by a bearer of it, no matter in what direction or angle it is held when said action is provided.

4. A handheld means according to claim 2, wherein a tilting of it in a vertical plane to its length axis determines the degree of manipulation of an object, and where a rotation of it around its axis determines an approval of the manipulation.

5. A handheld means according to claim 1, wherein a position detecting means for a 3-D determination of said pointer device (20) stylus position in space is an ultrasonic receiver/transmitter means (14).

6. A handheld means according to claim 1, wherein a position detecting means for a 3-D determination of said pointer device stylus position in space is a miniaturized camera means.

7. A handheld means according to claim 1, wherein a 3-D image provides a skin layer with menus.

8. A handheld means according to claim 7, wherein said first and second manipulating means is locked to a skin layer when having provided a tactile feedback, whereby said manipulating means is used for browsing on the skin layer surface, thus preventing slipping to an adjacent skin layer.

9. A handheld means according to claim 1, whereby it is a cellular phone.

10. A handheld means according to claim 1, whereby it is a palm-top-computer or the like.

11. A handheld means according to claim 1, wherein said screen is of an auto-stereoscopic type.

12. A method for a computerized portable handheld means (10) with a screen (16) displaying images of objects (19) to be manipulated, whereby a manipulation of objects connects a link to a sub-object or function to be performed, comprising the steps of: providing a first manipulating means for said objects, controlling the manipulation of said objects by movement of a hand holding said manipulating means; providing a second manipulating means for said objects, controlling the manipulation of said objects by a pointing device (20) when it is placed on another surface than a hand; and providing a means for tactile feedback to said hand for every successful possible manipulation of said objects, thereby providing a push-button free manipulation of objects and a feeling for the manipulation, thus enhancing the speed of manipulation by involving at least the two senses of seeing and feeling, and providing at least two functions of manipulating objects on a screen in accordance with said first and second means.

13. A method according to claim 12, wherein it is provided with a gyro, whereby the degree of tilting it, constitutes an input signal to said first and second manipulating means which controls the degree of manipulation of objects.

14. A method according to claim 12, wherein a zero base for a manipulation is provided by an agreement action provided by a bearer of it, no matter in what direction or angle it is held when said action is provided.

15. A method according to claim 13, wherein a tilting of the handheld means in a vertical plane to its length axis determines the degree of manipulation of an object, and where a rotation of it around its axis determines an approval of the manipulation.

16. A method according to claim 12, wherein a position detecting means for a 3-D determination of said pointer device (20) stylus position in space is an ultrasonic receiver/transmitter means (14).

17. A method according to claim 12, wherein a position detecting means for a 3-D determination of said pointer device (20) stylus position in space is a miniaturized camera means.

18. A method according to claim 12, wherein a 3-D image provides a skin layer with menus.

19. A method according to claim 18, wherein said first and second manipulating means is locked to a skin layer when having provided a tactile feedback, whereby said manipulating means is used for browsing on the skin layer surface, thus preventing slipping to an adjacent skin layer.

20. A method according to claim 12, whereby the handheld means is a cellular phone.

21. A method according to claim 12, whereby the handheld means is a palm-top-computer or the like.

22. A method according to claim 12, wherein said screen is of an autostereoscopic type.
